(19) United States
(12) Patent Application Publication
(10) Pub. No.: US 2014/0325126 A1
(43) Pub. Date: Oct. 30, 2014

(54) DATA STORAGE DEVICE PERFORMING ATOMIC WRITE AND RELATED METHOD OF OPERATION

(71) Applicant: Samsung Electronics Co., Ltd., Suwon-si (KR)

(72) Inventors: SANG HOON CHOI, SEOUL (KR); MOON SANG KWON, SEOUL (KR); ALAIN TRAN, SEOUL (KR); SANG PHIL LIM, SEOUL (KR); HYUNG JIN IM, HWASEONG-SI (KR)

(73) Assignee: Samsung Electronics Co., Ltd., Suwon-si (KR)

(21) Appl. No.: 14/263,597

(22) Filed: Apr. 28, 2014

(30) Foreign Application Priority Data
Apr. 29, 2013 (KR) 10-2013-0047772

(51) Int. Cl. G06F 3/06

(52) U.S. Cl. CPC G06F 3/0655; G06F 3/0688; G06F 3/0626
USPC 711/103; 711/173

(57) ABSTRACT

A method of operating a data storage device comprises allocating a plurality of data blocks among received data to a plurality of intellectual property (IP) cores, performing an atomic write independently for of the IP cores, wherein the atomic write for each of the IP cores writes corresponding allocated data blocks to a corresponding memory region of the data storage device, and generating an independent identifier indicating completion of the atomic write for each of the IP cores.

### CROSS-REFERENCE TO RELATED APPLICATIONS

This application claims priority under 35 U.S.C. §119(a) to Korean Patent Application No. 10-2013-0047772 filed on Apr. 29, 2013, the subject matter of which is hereby incorporated by reference.

### BACKGROUND OF THE INVENTION

Embodiments of the inventive concept relate to electronic memory technologies. More particularly, certain embodiments of the inventive concept relate to data storage devices performing an atomic write operation and related methods of operation.

An atomic write or atomic write operation is a write operation in which data is written to a designated location without intervening access to that location. During an atomic write operation, it may be necessary to block, postpone, or ignore incoming read operations, and it may also be necessary to compensate for unexpected interruptions such as a sudden loss of power. The complexity of an atomic write may be increased where some data is required to be stored in different locations, such as distinct physical chips or memory blocks.

### SUMMARY OF THE INVENTION

In one embodiment of the inventive concept, a method of operating a data storage device comprises allocating a plurality of data blocks in received data to a plurality of intellectual property (IP) cores, performing an atomic write independently for of the IP cores, wherein the atomic write for each of the IP cores writes corresponding allocated data blocks to a corresponding memory region of the data storage device, and generating an independent identifier indicating completion of the atomic write for each of the IP cores.

In another embodiment of the inventive concept, a method of operating a system comprising a host and a data storage device comprises transmitting, by the host, data to the data storage device, allocating, by the data storage device, data blocks in the data to IP cores, performing, by the data storage device, an atomic write independently for data blocks allocated to each of the IP cores, and generating, by the data storage device, independent identifiers indicating whether the atomic write is completed for each of the IP cores.

These and other embodiments of the inventive concept may provide improved buffering of data related to an atomic write, reduce a size of a write buffer buffering the data, and allow adaptation to a loss of power.

### BRIEF DESCRIPTION OF THE DRAWINGS

The drawings illustrate selected embodiments of the inventive concept. In the drawings, like reference numbers indicate like features.

FIG. 1 is a block diagram of a system according to an embodiment of the inventive concept.

FIG. 2 is a block diagram of a system according to another embodiment of the inventive concept.

FIG. 3 is a block diagram of a system according to still another embodiment of the inventive concept.

FIG. 4 is a block diagram of a system according to still another embodiment of the inventive concept.

FIG. 5 is a conceptual diagram for describing data transmission and an atomic write according to an embodiment of the inventive concept.

FIG. 6 is a conceptual diagram for describing data transmission and an atomic write according to another embodiment of the inventive concept.

FIG. 7 is a conceptual diagram for describing data transmission and an atomic write according to still another embodiment of the inventive concept.

FIGS. 8a to 8d are conceptual diagrams for describing data transmission and an atomic write according to still another embodiment of the inventive concept.

FIG. 9 is a conceptual diagram for describing data transmission and an atomic write of a data storage device comprising a capacitor, according to an embodiment of the inventive concept.

FIG. 10 illustrates a flash page comprising metadata having an end mark count, a transaction ID, and an end flag, according to an embodiment of the inventive concept.

FIG. 11 is a conceptual diagram for describing data transmission and an atomic write of a system using the metadata having an end mark count, a transaction ID, and an end flag, according to an embodiment of the inventive concept.

FIG. 12 is a block diagram of a system according to still another embodiment of the inventive concept.

FIG. 13 is a block diagram of a system according to still another embodiment of the inventive concept.

FIG. 14 is a flowchart illustrating an atomic write using multiple IP cores according to an embodiment of the inventive concept.

FIG. 15 is a flowchart illustrating an atomic write of a data storage device comprising the capacitor, according to an embodiment of the inventive concept.

FIG. 16 is a flowchart illustrating an atomic write of a system using the metadata comprising the end mark count, the transaction ID, and the end flag, according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, where a feature is referred to as being “connected” or “coupled” to another feature, it can be directly connected or coupled to the other feature or intervening features may be present. In contrast, where a feature is referred to as being “directly connected” or “directly coupled” to another feature, there are no intervening features present. As used herein, the term “and/or” encompasses any and all combinations of one or more of the associated listed items and may be abbreviated as “/”.

Although the terms first, second, etc. may be used herein to describe various features, the described features should not be limited by these terms. Rather, these terms are used merely to distinguish between different features. For example, a first signal could be termed a second signal, and, similarly, a second signal could be termed a first signal without departing from the teachings of this disclosure.

The terminology used herein is for the purpose of describing particular embodiments only and is not intended to limit the inventive concept. As used herein, the singular forms “a”, “an” and “the” encompass the plural forms as well, unless the context clearly indicates otherwise. Terms such as “comprises” and/or “comprising,” or “includes” and/or “including” where used in this specification, indicate the presence of stated features but do not preclude the presence or addition of one or more other features.

Unless otherwise defined, all terms (including technical and scientific terms) used herein have the same meaning as commonly understood by one of ordinary skill in the art. Terms such as those defined in commonly used dictionaries should be interpreted as having a meaning that is consistent with their meaning in the context of the relevant art and/or the present application, and should not be interpreted in an idealized or overly formal sense unless expressly so defined herein.

The term “intellectual property (IP) core”, as used herein, denotes data or logic (e.g., a semiconductor IP core, an IP block, an integrated circuit (IC), or a circuit block) used in making an application-specific integrated circuit (ASIC) or a field-programmable gate array (FPGA).

The term “module”, as used herein, denotes a set of features (e.g., hardware and/or software) capable of performing a designated function, and can be implemented, for instance, by computer code or an electronic recording medium equipped with a computer program code, such as a processor or a microprocessor. In other words, a module may comprise hardware, software, or a combination of hardware and software.

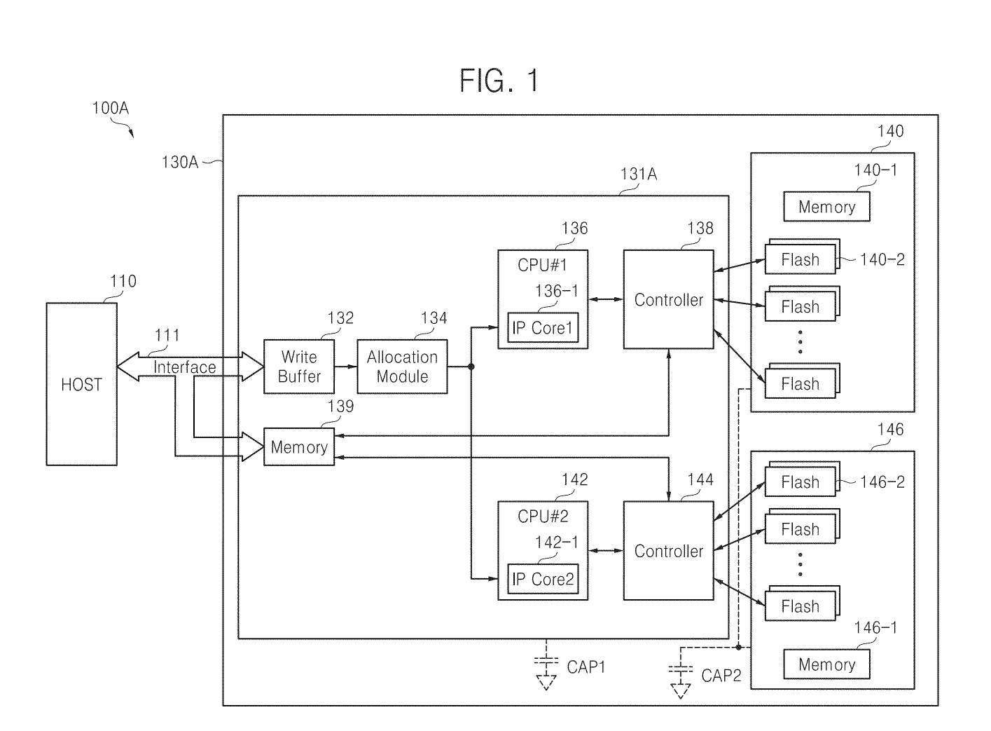

FIG. 1 is a block diagram of a system according to an embodiment of the inventive concept.

Referring to FIG. 1, a system 100A comprises a host 110 and a data storage device 130A.

System 100A may take the form of a personal computer (PC), a server, a data server, a database server, a web server, or a portable electronic device, for example. The portable electronic device may take the form of a laptop computer, a netbook, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, or an e-book, for example.

Data storage device 130A comprises a controller board 131A and memory boards 140 and 146. Controller board 131A and memory boards 140 and 146 communicate with each other through a corresponding channels.

Data storage device 130A may take the form of a flash-based database, a solid state drive (SSD), a universal flash storage (UFS), a flash universal serial bus (USB) drive, a secure digital (SD) card, a multimedia card (MMC), an embedded MMC, a smart card, or a memory card, for example.

Data storage device 130A communicates with host 110 through an interface 111. For example, interface 111 may support a serial advanced technology attachment (SATA) protocol, a Serial Attached SCSI (SAS) protocol or peripheral component interconnect express (PCIe). Interface 111 may take other forms in addition to a SATA interface or an SAS interface.

Controller board 131A comprises a first memory 132, an allocation module 134, CPUs 136 and 142, controllers 138 and 144, and a second memory 139.

Power is supplied to host 110 and data storage device 130A. The power supplied to host 110 and data storage device 130A may be the same or different. The power is supplied to each board 131A, 140, and 146. In addition, the power is supplied to each capacitor CAP1 and CAP2, so that each capacitor CAP1 and CAP2 may be charged.

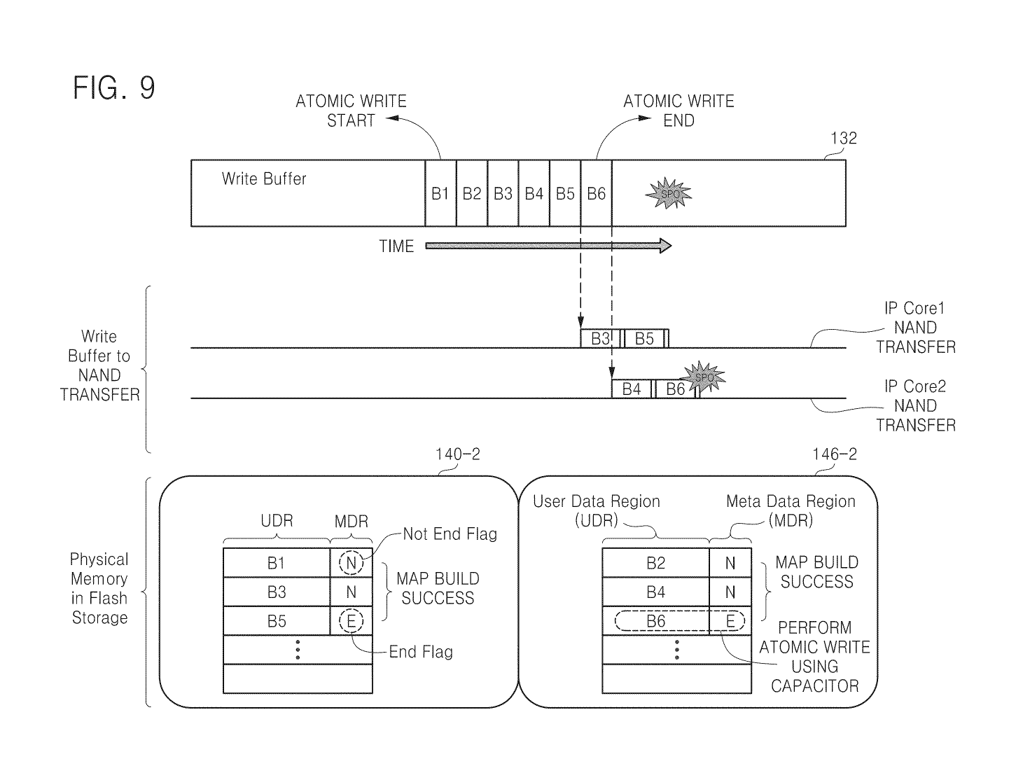

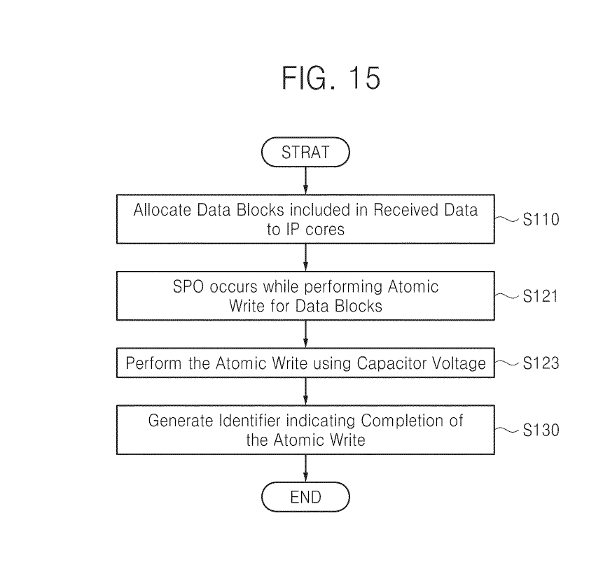

Capacitors CAP1 and CAP2 are used to provide power in the event of a sudden power off (SPO), and they may optionally be omitted or replaced by some other form of backup power. For convenience of description in FIG. 1, capacitors CAP1 and CAP2 are shown as separate structures. At least one element which may supply emergency power to each board 131A, 140, and 146 in case of an SPO may be used instead of one or both capacitors CAP1 and CAP2. An atomic write of data storage device 130A comprising each capacitor CAP1 and CAP2 will be described with reference to FIGS. 9 and 15.

First memory 132 may take the form of a random access memory (RAM), a dynamic RAM (DRAM), a static RAM (SRAM) or a non-volatile memory. The non-volatile memory may comprise non-volatile memory cells as described below. First memory 132 performs a function of a write buffer that stores or buffers data related to the atomic write transmitted from host 110 through interface 111.

Allocation module 134 receives data related to the atomic write stored in write buffer 132, and it performs a function of allocating data blocks in the received data to IP cores 136-1 and 142-1. Here, a data block is a set of bits having a defined size for processing, sector data, chunk data, or page data.

Allocation module 134 divides the received data into data blocks, and it allocates the divided data blocks to IP cores 136-1 and 142-1. In various alternative embodiments, allocation module 134 allocates the data blocks to IP cores 136-1 and 142-1 based on addresses of data blocks in the received data, e.g., a logical block address (LBA). For example, where two IP cores 136-1 and 142-1 are included in data storage device 130A, allocation module 134 may allocate data blocks stored in storage regions corresponding to odd numbered LBAs of write buffer 132 to IP core 136-1, and allocate data blocks stored in storage regions corresponding to even numbered LBAs of write buffer 132 to IP core 142-1.

Allocation module 134 performs a function of allocating the data blocks in the received data to the IP cores based on the number of IP cores in data storage device 130A. Various alternative methods may be used to allocate the data blocks in the received data to the IP cores. For example, allocation module 134 may allocate the data blocks to the IP cores according to a round-robin method.

In some embodiments, allocation module 134 of FIG. 1 may take the form of independent hardware in addition to multiple CPUs 136 and 142. In other embodiments, where allocation module 134 of FIG. 1 comprises firmware or software, allocation module 134 may be performed by one of CPUs 136 and 142.

CPUs 136 and 142 communicate with host 110 through interface 111. CPUs 136 and 142 receive a command output from host 110, and control corresponding controllers 138 and 144 based on the received command. CPUs 136 and 142 comprise corresponding IP cores 136-1 and 142-1. For convenience of description in FIG. 1, CPUs 136 and 142 each comprise one IP core 136-1 and 142-1, but they could include more.

Controllers 138 and 144 control access operations, e.g., write operations, atomic write operations, read operations, or erase operations, of corresponding memory chips 140-2 or 146-2. Memory chips 140-2 and 146-2 are storage regions storing data related to atomic write, and a storage region allocated to IP cores 136-1 and 142-1.

Second memory 139 transmits data output from memory chips 140-2 and 146-2 to host 110 through interface 111 under control of controllers 138 and 144. Second memory 139 stores data, and the data is loaded to controllers 138 and 144. For example, second memory 139 may store program code or firmware necessary for an operation of CPUs 136 and 142. Accordingly, the second memory described as a set of multiple memories may comprise a volatile memory chip and/or a non-volatile memory chip.

Data storage device 130A stores data or atomic data related to an atomic write in a memory chip 140-2 and/or 146-2. Host 110 writes data or atomic data in memory chip 140-2 and/or 146-2. In addition, host 110 may read data or atomic data from memory chip 140-2 and/or 146-2.

A data write operation and a data read operation between host 110 and memory chips 140-2 and 146-2 is processed under control of CPU 136 and 142 and/or controllers 138 and 144. Memory boards 140 and 146 comprise multiple memory chips 140-2 and 146-2. For convenience of description in FIG. 1, memory chips 140-2 and 146-2 are flash memory chips, but the type of these memory chips may be variously changed.

Memory chips 140-2 and 146-2 comprise non-volatile memory cells, each of which may take the form of an Electrically Erasable Programmable Read-Only Memory (EEPROM), a flash memory, a Magnetic RAM (MRAM), a Spin-Transfer Torque MRAM, a Conductive bridging RAM (CBRAM), a Ferroelectric RAM (FeRAM), a Phase change RAM (PRAM), a Resistive RAM (RRAM), a Nanotube RRAM, a Polymer RAM (PoRAM), a Nano Floating Gate Memory (NFGM), a holographic memory, a Molecular Electronics Memory Device, or an Insulator Resistance Change Memory, for example. Each of the non-volatile memory cells may store one or more bits.

Memory chips 140-2 and 146-2 may be the same or different types of memory chips. For example, memory chips 140-2 may be NAND flash memory chips comprising single-level cells (SLCs) which may store one-bit information per cell, and memory chips 146-2 may be NAND flash memory chips comprising multi-level cells (MLCs) storing two or more bits of information per cell.

Memory boards 140 and 146 further comprise memories 140-1 and 146-1, where memories 140-1 and 146-1 store information related to memory chips 140-2 and 146-2. For example, memories 140-1 and 146-1 may store property information of memory chips 140-2 and 146-2. The property information comprises type information of memory chips 140-2 and 146-2, e.g., information on whether each of memory chips 140-2 and 146-2 is a SLC chip or a MLC chip, information on whether each of memory chips 140-2 and 146-2 is NAND chip or NOR chip, information on the number of blocks in each of memory chips 140-2 and 146-2, and information on the number of pages per block, the number of bytes per page, or each operation of memory chips 140-2 and 146-2. Memory boards 140 and 146 may be separated from controller board 131A.

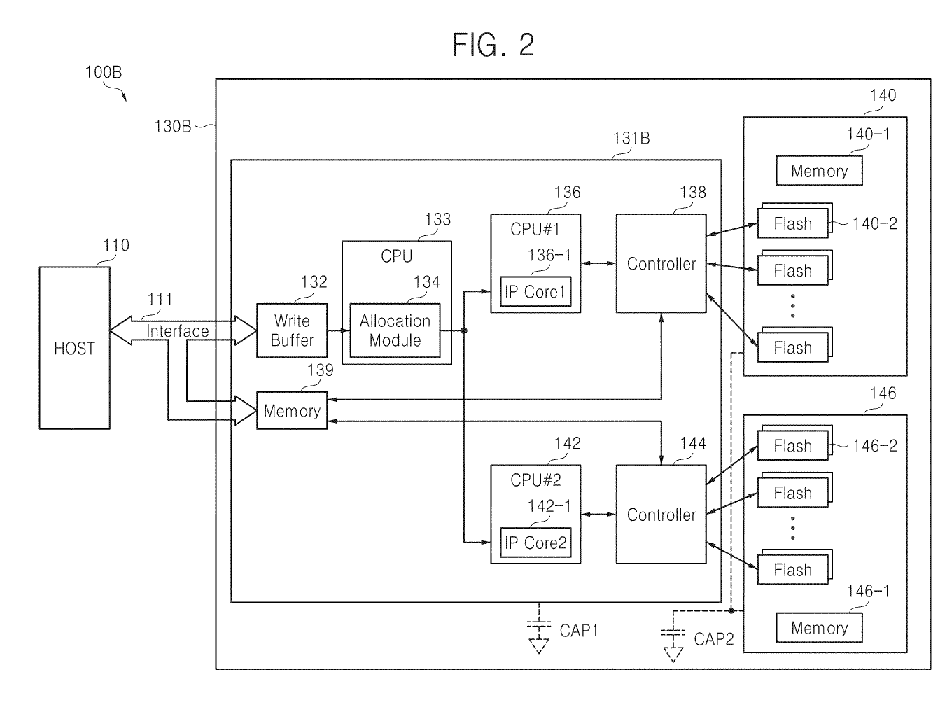

FIG. 2 is a block diagram of a system according to another embodiment of the inventive concept.

Referring to FIGS. 1 and 2, allocation module 134 in the form of firmware may be executed by an additional CPU 133.

Except for allocation module 134 executed by CPU 133, the structure and operation of a data storage device 130B comprising a controller board 131B of FIG. 2 are substantially the same as a structure and an operation of data storage device 130A comprising controller board 131A of FIG. 1.

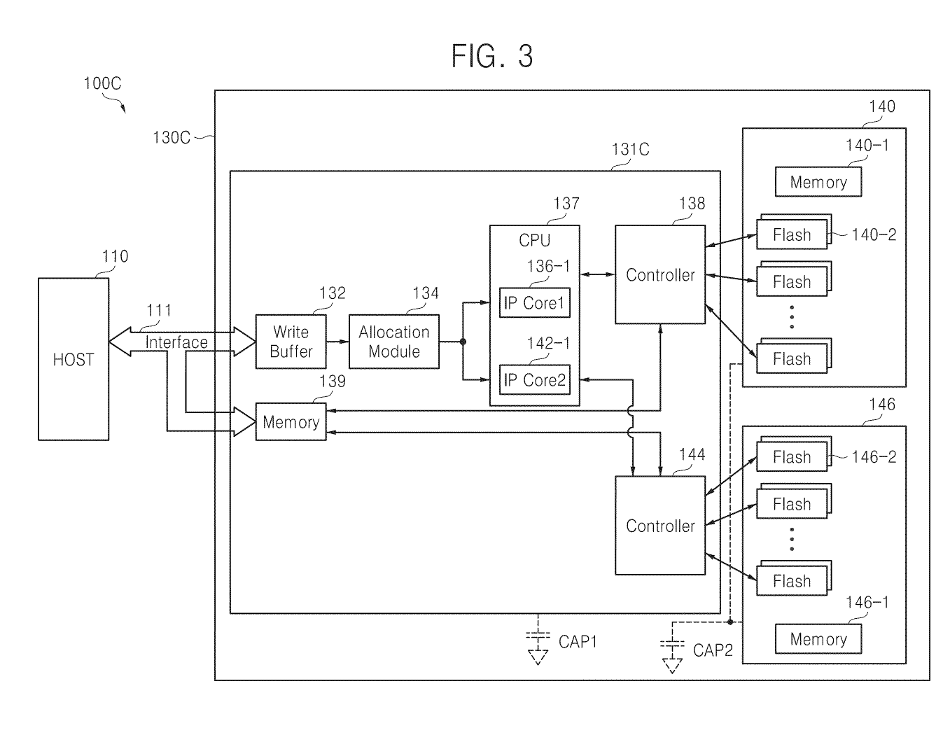

FIG. 3 is a block diagram of a system according to still another embodiment of the inventive concept.

Referring to FIGS. 1 and 3, except that multiple IP cores 136-1 and 142-1 are included in one CPU 137, and each controller 138 and 144 is controlled by each IP core 136-1 and 142-1, a structure and an operation of a data storage device 130C comprising a controller board 131C of FIG. 3 are substantially the same as a structure and an operation of data storage device 130A comprising controller board 131A of FIG. 1.

According to an embodiment, allocation module 134 of FIG. 3 may take the form of independent hardware in addition to CPU 137. According to another embodiment, where allocation module 134 of FIG. 3 comprises firmware or software, it may be executed by CPU 137 or one of IP cores 136-1 and 142-1.

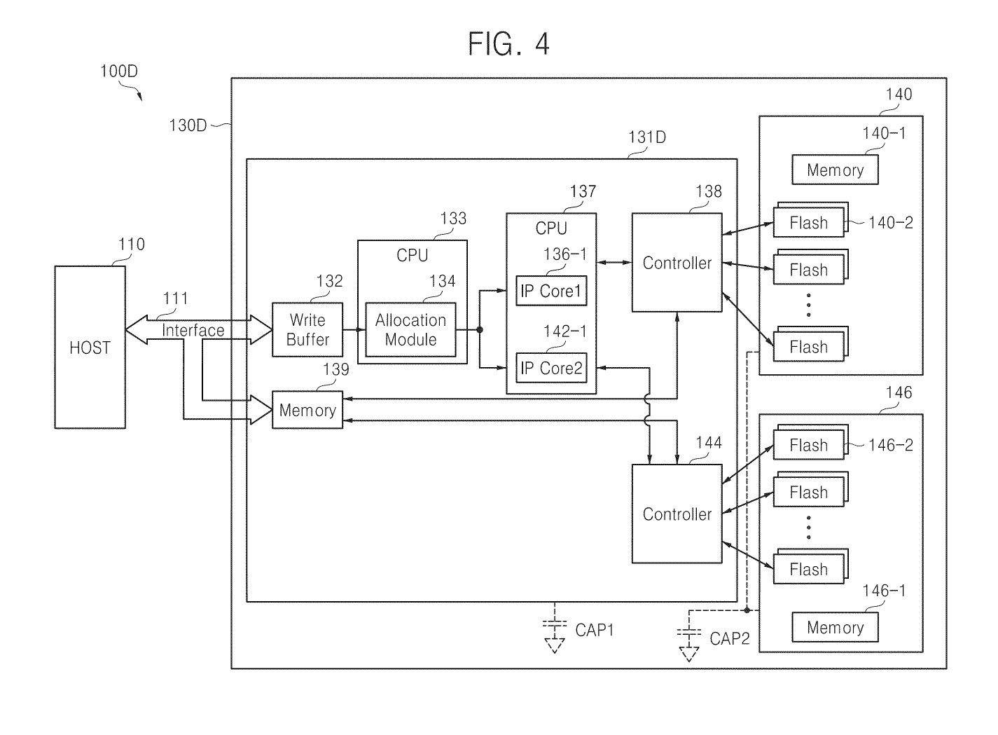

FIG. 4 is a block diagram of a system according to still another embodiment of the inventive concept.

Referring to FIGS. 3 and 4, allocation module 134 in the form of firmware is executed by an additional CPU 133. Except for allocation module 134 executed by CPU 133, a structure and a operation of data storage device 130D comprising a controller board 131D of FIG. 4 are substantially the same as a structure and an operation of data storage device 130C comprising controller board 131C of FIG. 3.

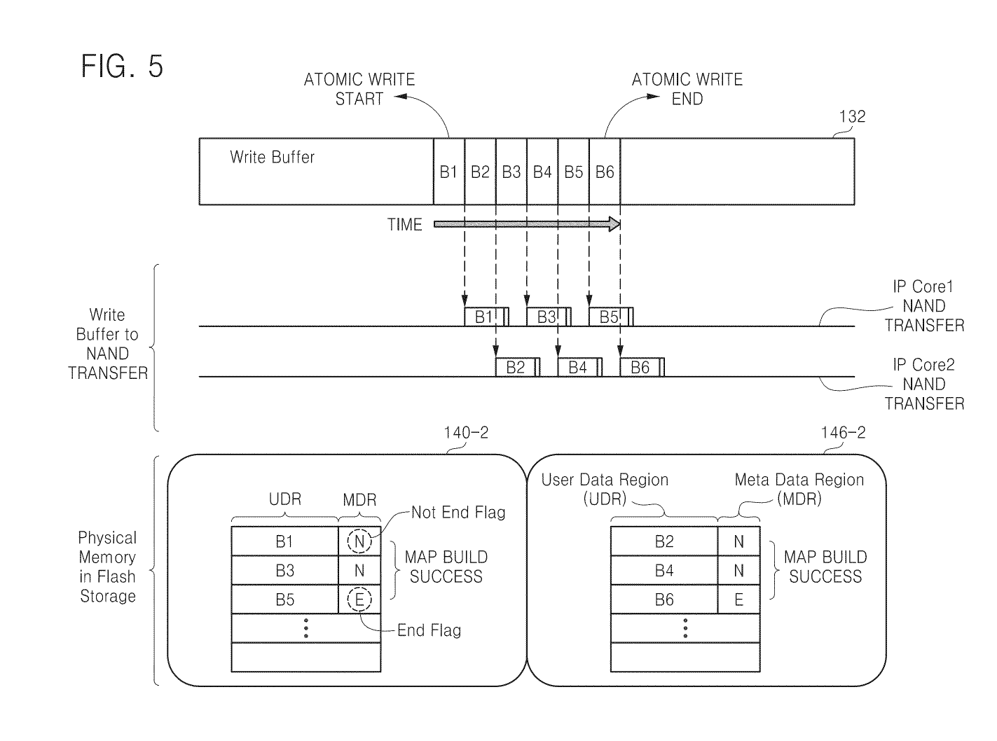

FIG. 5 is a conceptual diagram for describing a data transmission and an atomic write according to an embodiment of the inventive concept.

Referring to FIGS. 1 to 5, each of data blocks B1 to B6 for data related to the atomic write transmitted from host 110 is transmitted to allocation module 134 while being buffered by write buffer 132. Allocation module 134 allocates data blocks B1 to B6 transmitted from write buffer 132 to one of IP cores 136-1 and 142-1. For example, allocation module 134 may allocate odd numbered data blocks B1, B3, and B5 among data blocks B1 to B6 to IP core 136-1, and allocate even numbered data blocks B2, B4, and B6 among data blocks B1 to B6 to IP core 142-1. The odd numbered data blocks B1, B3, and B5 allocated to IP core 136-1 are atomically stored in a first memory region allocated to IP core 136-1 under control of IP core 136-1.

The first memory region may be defined in one or more memory chips of memory board 140 (a first memory board). That is, the odd numbered data blocks B1, B3, and B5 may be atomically written in one memory chip in memory board 140, or divided and atomically written in at least two memory chips in memory board 140.

IP core 136-1 performs an atomic write for the odd numbered data blocks B1, B3, and B5 allocated to IP core 136-1. Here, controller 138 may atomically write the odd numbered data blocks B1, B3, and B5 in the first memory region allocated to IP core 136-1 under control of IP core 136-1.

For convenience of description, FIG. 5 shows a process in which the odd numbered data blocks B1, B3, and B5 are atomically written in one memory chip 140-2. After a first data block B1 is written in a user's data region UDR of memory chip 140-2, IP core 136-1 generates an identifier N, and identifier N is written in a metadata region MDR storing metadata or a spare region. After a third data block B3 is written in a user data region UDR of memory chip 140-2, IP core 136-1 generates identifier N, and identifier N is written in metadata region MDR storing metadata or the spare region.

After a last data block B5 allocated to IP core 136-1 is written in a user data region UDR of memory chip 140-2, IP core 136-1 generates an identifier E, and identifier E is written in the metadata region MDR storing metadata or the spare region. Identifier E is an identifier for controlling atomicity of the atomic write may be generated by IP core 136-1 after the last data block B5 among data blocks B1, B3, and B5 allocated to IP core 136-1 is written in the user data region UDR of memory chip 140-2. However, among data blocks B1, B3, and B5 allocated to IP core 136-1, after each of data blocks B1 and B3 is written in the user data region UDR of memory chip 140-2, IP core 136-1 generates identifier N. Here, identifier N denotes a Not End Flag or a not end mark, and identifier E denotes an End Flag or an end mark. For example, N and E perform a function of a status bit indicating whether the atomic write is completed.

Where identifier E for the last data block B5 allocated to IP core 136-1 is written or programmed in the user data region UDR of memory chip 140-2, identifier E indicates the atomic write is normally performed by IP core 136-1.

IP core 136-1 checks an identifier during scanning and checks whether the atomic write is completed. When an identifier for the last data block B5 is E, IP core 136-1 performs map build MAP BUILD generating a logical-to-physical map. That is, where the identifier for the last data block B5 is E, the atomic write or the map build is successfully performed.

In this case, where host 110 performs a read operation, new data blocks stored in memory chip 140-2, i.e., data blocks B1, B3, and B5 atomically written, are transmitted to host 110. However, where an identifier for the last data block B5 is N, the atomic write for IP core 136-1 fails to be performed. In this case, where host 110 performs a read operation, old data blocks stored in memory chip 140-2 are transmitted to host 110.

Even numbered data blocks B2, B4, and B6 allocated to IP core 142-1 may be atomically stored in a second memory region allocated to IP core 142-1 under control of IP core 142-1. The second memory region may be defined in one memory chip in memory board 146 (a second memory board), or in at least two memory chips in memory board 146. That is, the even numbered data blocks B2, B4, and B6 may be atomically written in one memory chip in memory board 146 or divided and atomically written in at least two memory chips in memory board 146.

IP core 142-1 performs an atomic write for the even numbered data blocks B2, B4, and B6 allocated to IP core 142-1. Here, controller 144 atomically writes the even numbered data blocks B2, B4, and B6 to a second memory region allocated to IP core 142-1 under control of IP core 142-1. For convenience of description, FIG. 5 shows a process in which the even numbered data blocks B2, B4, and B6 are atomically written in one memory chip 146-2. After a second data block B2 is written in the user data region UDR of memory chip 146-2, IP core 142-1 generates an identifier N, and identifier N is written in metadata region MDR storing metadata or a square region. After a fourth data block B4 is written in a user data region UDR of memory chip 146-2, IP core 142-1 generates an identifier N, and identifier N is written in metadata region MDR storing metadata or the spare region.

After a last data block B6 allocated to IP core 142-1 is written in the user data region UDR of memory chip 146-2, IP core 142-1 generates an identifier E, and identifier E is written in the metadata region MDR storing metadata or the spare region.

Identifier E, which is an identifier that controls atomicity of the atomic write, is generated by IP core 142-1 after a last data block B6 among data blocks B2, B4, and B6 allocated to IP core 142-1 is written in the user data region UDR of memory chip 146-2. Among data blocks B2, B4, and B6 allocated to IP core 142-1, each of data blocks B2 and B4 is written in the user data region UDR of memory chip 146-2, and IP core 142-1 generates an identifier N.

As described above, the identifier N constitutes a Not End Flag, and the identifier E constitutes an End Flag. Where identifier E for the last data block B6 allocated to IP core 142-1 is written or programmed in the user data region UDR of memory chip 146-2, identifier E indicates the atomic write is successfully performed by IP core 142-1.

IP core 142-1 checks an identifier during scanning and checks whether the atomic write is completed. Where an identifier for the last data block B5 is E, IP core 142-1 performs a map build MAP BUILD to generate a logical-to-physical map. That is, where an identifier for the last data block B5 is E, the map build is successfully performed. In this case, where host 110 performs a read operation, new data blocks stored in memory chip 146-2, i.e., data blocks B2, B4, and B6 atomically written, are transmitted to host 110. However, where an identifier for the last data block B6 is N, an atomic write or map build by IP core 142-1 fails to be performed. In this case, where host 110 performs a read operation, old data blocks stored in memory chip 146-2 are transmitted to host 110.

As described above, each of multiple IP cores 136-1 and 142-1 in data storage device 130A to 130D (collectively ‘130’) performs the atomic write for data blocks allocated to each of IP cores 136-1 and 142-1, and independently generates an identifier E indicating completion of each atomic write. Accordingly, data storage device 130 transmits data satisfying atomicity to host 110 in response to a data read command from host 110.

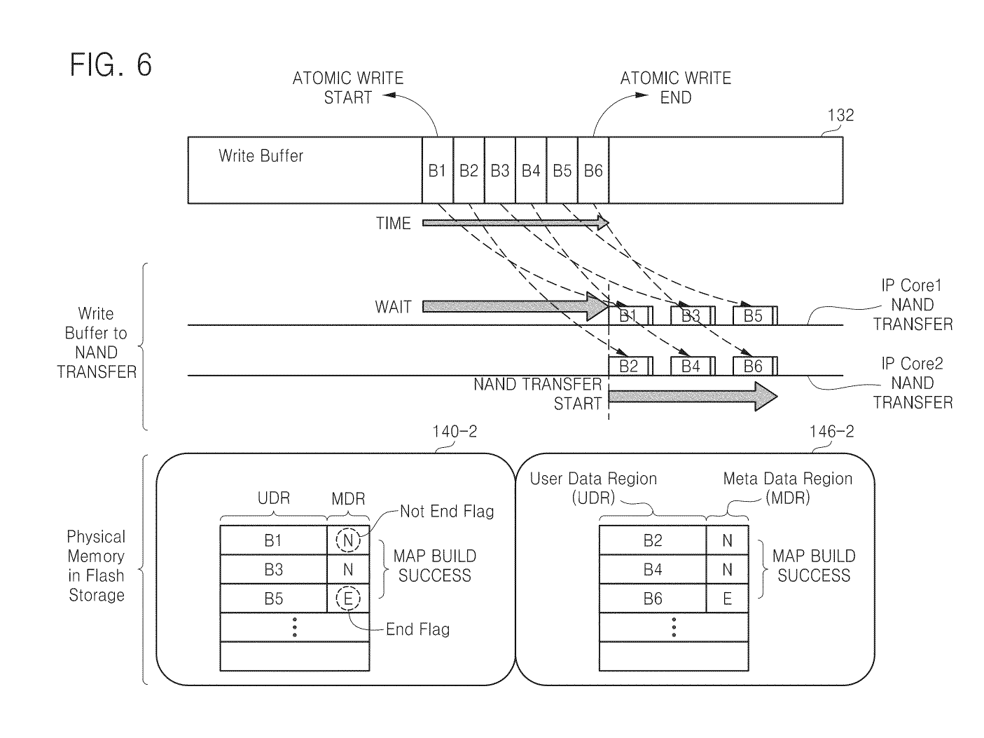

FIG. 6 is a conceptual diagram illustrating a data transmission and an atomic write according to another embodiment of the inventive concept.

Referring to FIGS. 1 to 4, and 6, all of data blocks B1 to B6 for data related to the atomic write transmitted from host 110 are transmitted to allocation module 134 after being buffered by write buffer 132. Allocation module 134 allocates data blocks B1 to B6 transmitted from write buffer 132 to IP cores 136-1 and 142-1. As described above, allocation module 134 allocates odd numbered data blocks B1, B3, and B5 among data blocks B1 to B6 to IP core 136-1, and allocates even numbered data blocks B2, B4, and B6 to IP core 142-1.

Odd numbered data blocks B1, B3, and B5 allocated to IP core 136-1 are atomically stored in a first memory region allocated to IP core 136-1 in a sequential manner under control of IP core 136-1. Even numbered data blocks B2, B4, and B6 allocated to IP core 142-1 are atomically stored in a second memory region allocated to IP core 142-1 in a sequential manner under control of IP core 142-1.

Among the odd numbered data blocks B1, B3, and B5 allocated to IP core 136-1, where an identifier E for the last data block B5 is written or programmed in the user data region UDR of memory chip 140-2, identifier E indicates the atomic write for IP core 136-1 is normally performed.

As described with reference to FIG. 5, where the identifier for the last data block B5 is E, IP core 136-1 performs a map build MAP BUILD to generate a logical-to-physical map. That is, where an identifier for the last data block B5 is E, map build MAP BUILD is successfully performed.

Among even numbered data blocks B2, B4, and B6 allocated to IP core 142-1, where an identifier E for the last data block B6 is written or programmed in the user data region UDR of memory chip 146-2, identifier E indicates the atomic write is normally performed by IP core 142-1.

As described with reference to FIG. 5, where an identifier for the last data block B6 is E, IP core 142-1 performs a map build MAP BUILD generating a logical-to-physical map. That is, where an identifier for the last data block B5 is E, map build MAP BUILD is successfully performed.

As described above, each of IP cores 136-1 and 142-1 in data storage device 130 may perform an atomic write for data blocks allocated to IP cores 136-1 and 142-1, and independently generate an identifier indicating a completion of each atomic write. Accordingly, data storage device 130 may transmit data satisfying atomicity to host 110 in response to a data read command from host 110.

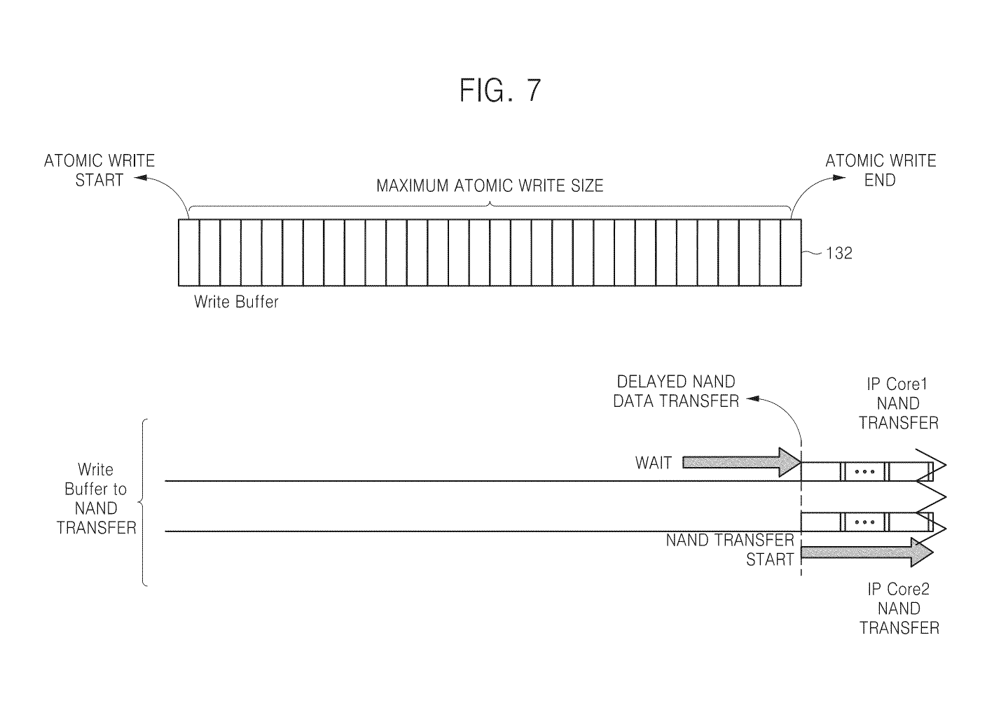

FIG. 7 is a conceptual diagram for describing a data transmission and an atomic write according to still another embodiment of the inventive concept.

Referring to FIGS. 1 to 4, 6 and 7, similar to the atomic write illustrated in FIG. 6, data blocks in data related to the atomic write transmitted from host 110 are fully written in write buffer 132, and then data blocks written in write buffer 132 are transmitted to allocation module 134.

Allocation module 134 allocates odd numbered data blocks among the data blocks to IP core 136-1, and allocates even numbered data blocks among the data blocks to IP core 142-1. The odd numbered data blocks allocated to IP core 136-1 are atomically stored in the first memory region allocated to IP core 136-1 in a sequential manner under control of IP core 136-1.

As described with reference to FIGS. 5 and 6, where an identifier for a last odd numbered data block is E, IP core 136-1 performs a map build to generate a logical-to-physical map. That is, where an identifier for the last data block B5 is E, the map build is successfully performed. The even numbered data blocks allocated to IP core 142-1 may be atomically stored in the second memory region allocated to IP core 142-1 in a sequential manner under control of IP core 142-1.

As described with reference to FIGS. 5 and 6, where an identifier for the last even numbered data block is E, IP core 142-1 performs a map build generating the logical-to-physical map. That is, when an identifier for the last data block B5 is E, the map build is successfully performed.

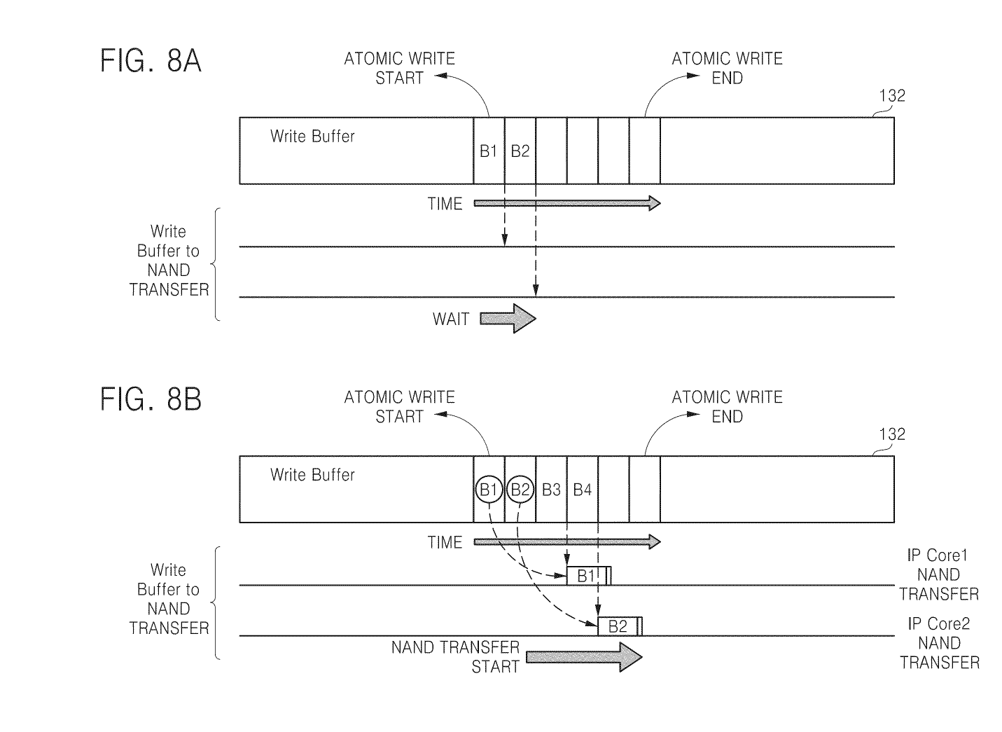

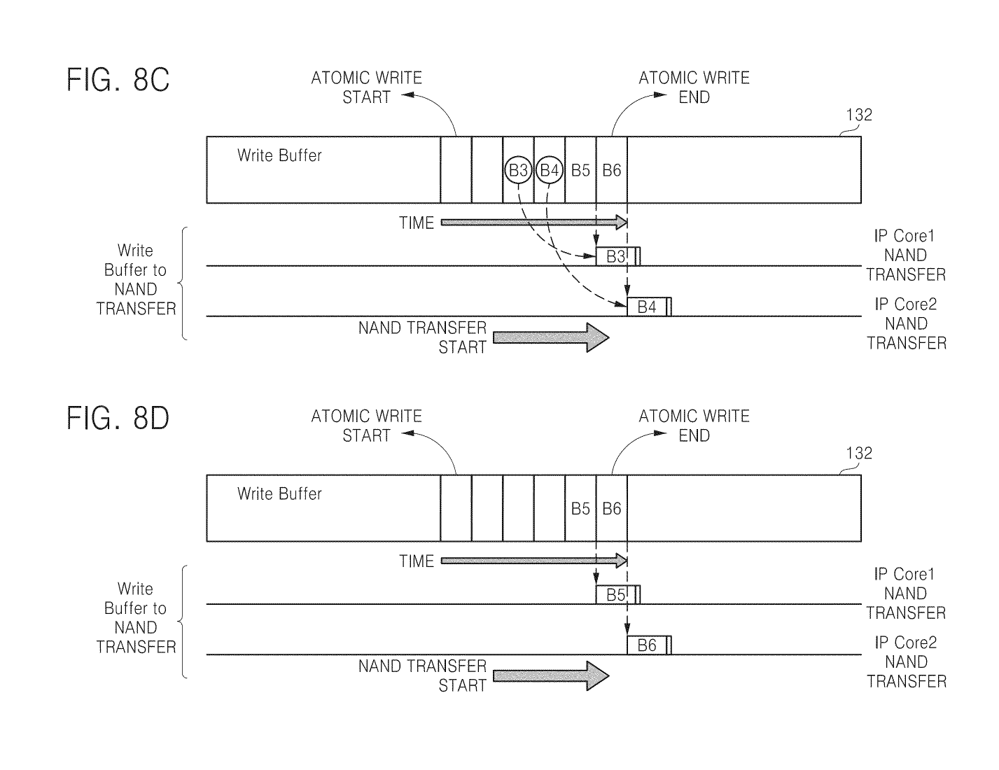

FIGS. 8A to 8D are conceptual diagrams for describing a data transmission and an atomic write according to still another embodiment of the inventive concept. Where a size of atomic data related to the atomic write is greater than a size of write buffer 132, a method for increasing a processing speed of the atomic data and controlling atomicity of the atomic data regardless of an SPO or a sudden power off reset (SPOR) is described with reference to FIGS. 1 to 4 and 8A to 8D.

Referring to FIGS. 1 to 4 and 8A to 8D, a course in which write buffer 132 delays a data block to be allocated to IP cores 136-1 and 142-1 is described.

As illustrated in FIG. 8A, data blocks B1 and B2 in data related to the atomic write transmitted from host 110 are written in write buffer 132 as illustrated in FIG. 8A. Here, write buffer 132 does not transmit data blocks B1 and B2 to allocation module 134.

As illustrated in FIG. 8B, data blocks B3 and B4 in the data are written in write buffer 132 from host 110, write buffer 132 transmits previous data blocks B1 and B2 to allocation module 134.

Here, where data blocks B1 and B2 are transmitted to allocation module 134, buffer regions of write buffer 132 storing data blocks B1 and B2 become free regions, and therefore new data blocks transmitted from host 110 may be written in the buffer regions. Here, data blocks B1 and B2 are previous data blocks, and data blocks B3 and B4 are current data blocks.

Allocation module 134 allocates a first data block B1 transmitted from write buffer 132 to IP core 136-1, and allocates a second data block B2 transmitted from write buffer 132 to IP core 142-1. IP core 136-1 writes first data block B1 in the first memory region of memory board 140 using controller 138, and write second data block B2 in the second memory region of memory board 146 using controller 144.

As illustrated in FIG. 8C, when data blocks B5 and B6 in the data are written in write buffer 132 from host 110, write buffer 132 transmits the previous data blocks B3 and B4 to allocation module 134. Here, where data blocks B3 and B4 are transmitted to allocation module 134, buffer regions of write buffer 132 storing data blocks B3 and B4 become free regions, and therefore new data blocks transmitted from host 110 may be written in the buffer regions. Here, data blocks B3 and B4 are previous data blocks, and data blocks B5 and B6 are current data blocks.

Allocation module 134 allocates a third data block B3 transmitted from write buffer 132 to IP core 136-1, and allocates a fourth data block B4 transmitted from write buffer 132 to IP core 142-1. IP core 136-1 writes a third data block B3 in the first memory region of memory board 140 using controller 138, and it writes a fourth data block B4 in the second memory region of memory board 146 using controller 144.

As illustrated in FIG. 8D, write buffer 132 transmits last data blocks B5 and B6 to allocation module 134. Here, where data blocks B5 and B6 are transmitted to allocation module 134, buffer regions of write buffer 132 stored in data blocks B5 and B6 become free regions, and accordingly new data blocks transmitted from host 110 may be written in the buffer regions.

Allocation module 134 allocates a fifth data block B5 transmitted from write buffer 132 to IP core 136-1, and it allocates a sixth data block B6 transmitted from write buffer 132 to IP core 142-1. IP core 136-1 writes a fifth data block B5 in the first memory region of memory board 140 using controller 138, and writes a sixth data block B6 in the second memory region of memory board 146 using controller 144.

Where the atomic write for data blocks B1, B3, and B5 allocated to IP core 136-1 is completed, IP core 136-1 generates an identifier E indicating a completion of the atomic write, and write an identifier E in the first memory region of memory board 140. Where the atomic write for data blocks B2, B4, and B6 allocated to IP core 142-1 is completed, IP core 142-1 generates an identifier E indicating a completion of the atomic write, and write an identifier E in the second memory region of memory board 140.

Referring to FIGS. 1 to 4, and 8A to 8D, a process in which allocation module 134 delays a corresponding data block to be allocated to each of IP cores 136-1 and 142-1.

As illustrated in FIG. 8A, data blocks B1 and B2 in data related to the atomic write transmitted from host 110 are written in write buffer 132, and the written data blocks B1 and B2 are transmitted to allocation module 134.

Allocation module 134 allocates a first data block B1 to IP core 136-1, and allocates a second data block B2 to IP core 142-1. However, first IP cores 136-1 and 142-1 do not transmit data blocks B1 and B2 to controllers 138 and 144.

As illustrated in FIG. 8B, data blocks B3 and B4 in the data are written in write buffer 132 from host 110, and the written data blocks B3 and B4 are transmitted to allocation module 134. Here, data blocks B1 and B2 are previous data blocks, and data blocks B3 and B4 are current data blocks.

Allocation module 134 allocates a third data block B3 to IP core 136-1, and allocates a fourth data block B4 to IP core 142-1. IP core 136-1 writes a first data block B1 transmitted from allocation module 134 in a first memory region of memory board 140 using controller 138, and it writes a second data block B2 transmitted from allocation module 134 in a second memory region of memory board 146 using controller 144.

As illustrated in FIG. 8C, data blocks B5 and B6 in the data are written in write buffer 132 from host 110, and the written data blocks B5 and B6 are transmitted to allocation module 134. Here, data blocks B3 and B4 are previous data blocks, and data blocks B5 and B6 are current data blocks.

Allocation module 134 allocates a fifth data block B5 to IP core 136-1, and allocates a sixth data block B6 to IP core 142-1. IP core 136-1 writes a third data block B3 transmitted from allocation module 134 in the first memory region of memory board 140 using controller 138, and writes a fourth data block B4 transmitted from allocation module 134 in the second memory region of memory board 146 using controller 144.

As illustrated in FIG. 8D, IP core 136-1 writes a fifth data block B5 transmitted from allocation module 134 in the first memory region of memory board 140 using controller 138, and writes a sixth data block B6 transmitted from allocation module 134 in the second memory region of memory board 146 using controller 144.

Where the atomic write for data blocks B1, B3, and B5 allocated to IP core 136-1 is completed, IP core 136-1 generates an identifier E indicating a completion of the atomic write, and writes identifier E in the first memory region of memory board 140.

Where the atomic write for data blocks B2, B4, and B6 allocated to IP core 142-1 is completed, IP core 142-1 generates an identifier E indicating a completion of the atomic write, and writes identifier E in the second memory region of memory board 140.

FIG. 9 is a conceptual diagram for describing data transmission and an atomic write of a data storage device comprising a capacitor. Data storage device 130A, 130B, 130C, and 130D (collectively ‘130’) illustrated in FIGS. 1 to 4 comprise capacitors CAP1 and CAP2.

First, it is assumed that data storage device 130 does not comprise either of capacitors CAP1 and CAP2. Under these circumstances, after each data block B1, B3, and B5 is atomically written in memory chip 140-2, when a power supplied to data storage device 130 is suddenly off while a data block B6 is written in memory chip 146-2, each data block B2, B4, and B6 is not atomically written in memory chip 146-2. That is, the atomic write for each data block B2, B4, and B6 fails to be performed. Here, a completion flag E for data block B6 is not generated.

During a read operation of data block B1 to B6, memory chip 140-2 transmits new data, i.e., each data block B1, B3, and B5, to host 110, or memory chip 146-2 transmits old data, i.e., each old data block corresponding to each data block B2, B4, and B6 to host 110. In this case, atomicity for data blocks B1 to B6 is not guaranteed.

Second, it is assumed that data storage device 130 comprises each capacitor CAP1 and CAP2. Under these circumstances, after each data block B1, B3, and B5 is atomically written in memory chip 140-2, when a power supplied to data storage device 130 is suddenly off while data block B6 is written in memory chip 146-2, data block B6 is written in memory chip 146-2 using a voltage stored in each capacitor CAP1 and CAP2. That is, even if an SPO occurs in data storage device 130, each data block B2, B4, and B6 is atomically written in memory chip 146-2.

During a read operation of data blocks B1 to B6, memory chip 140-2 transmits new data, i.e., each data block B1, B3, and B5, to host 110, and memory chip 146-2 transmits new data, i.e., each data block B2, B4, and B6, to host 110. In this case, atomicity for data blocks B1 to B6 is guaranteed.

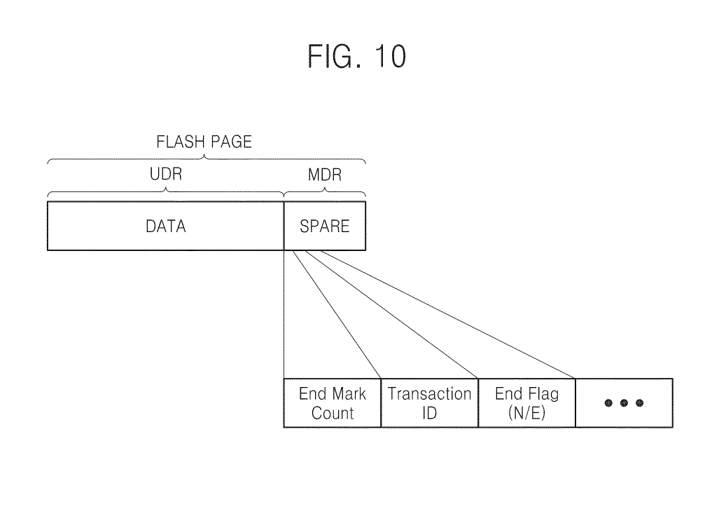

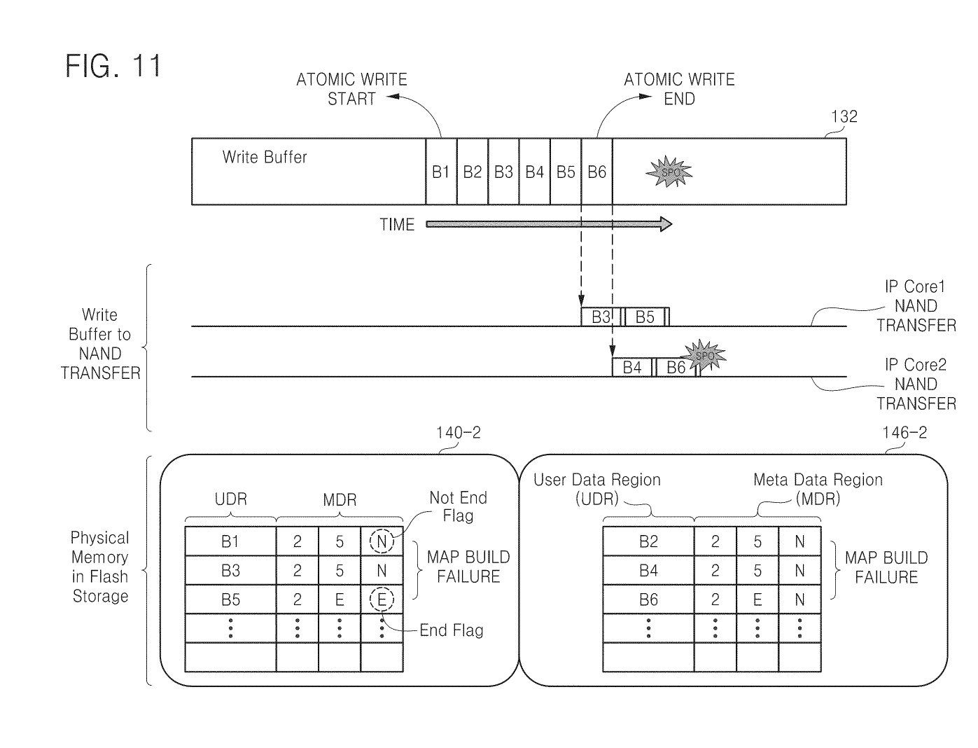

FIG. 10 illustrates a flash page comprising metadata comprising an end mark count, transaction ID, and an end flag, according to an embodiment of the inventive concept.

The end mark count or end flag count indicates the number of IP cores processing data related to the atomic write, the number of end marks or end flags necessary for completing the atomic write, or the number of data blocks comprising the end mark or end flag necessary for completing the atomic write, the transaction ID indicates an ID identifying a transaction or an ID identifying whether atomic write data per data block are identical, and the end flag indicates whether the atomic write is completed.

Metadata stored in metadata region MDR in FIGS. 5, 6, and 9 are flags N or E indicating whether the atomic write is completed. However, metadata stored in metadata region MDR of FIG. 10 further comprises the end mark count and the transaction ID in addition to flag N or E indicating whether the atomic write is completed.

FIG. 11 is a conceptual diagram for describing data transmission of a system using the metadata comprising an end mark count, transaction ID, and an end flag, and the atomic write.

Referring to FIGS. 10 and 11, it is assumed that data storage device 130 does not comprise each capacitor CAP1 and CAP2, the end mark count is ‘2’, and the transaction ID is ‘5’.

After each data block B1, B3, and B5 is atomically written in memory chip 140-2, when a power supplied to data storage device 130 is suddenly off while data block B6 is written in memory chip 146-2, end flag E is stored in metadata region MDR of memory chip 140-2, but end flag E is not stored in metadata region MDR of memory chip 146-2.

In this case, the number of end flags necessary for completing the atomic write for data blocks B1 to B6 is set to ‘2’; however, the number of end flags E which are actually generated is ‘1’. The atomic write for data blocks B1 to B6 fails to be performed. Accordingly, each IP core 136-1 and 142-1 does not perform a map build.

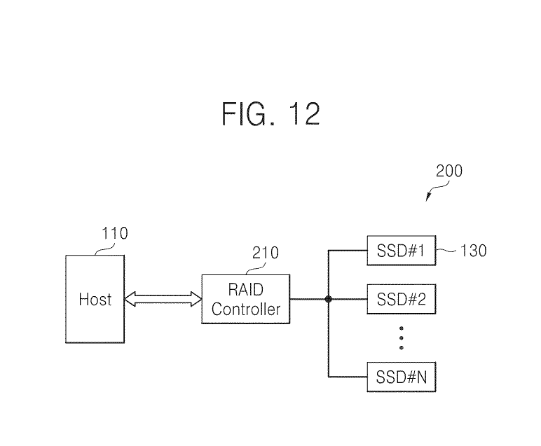

FIG. 12 is a block diagram of a system according to still another embodiment of the inventive concept.

Referring to FIG. 12, a system 200 comprises host 110, a redundant array of independent disk (RAID) controller 210, and multiple data storage devices 130, e.g., multiple SSDs. A structure and an operation of each of data storage devices 130 are as described with reference to FIGS. 1 to 11.

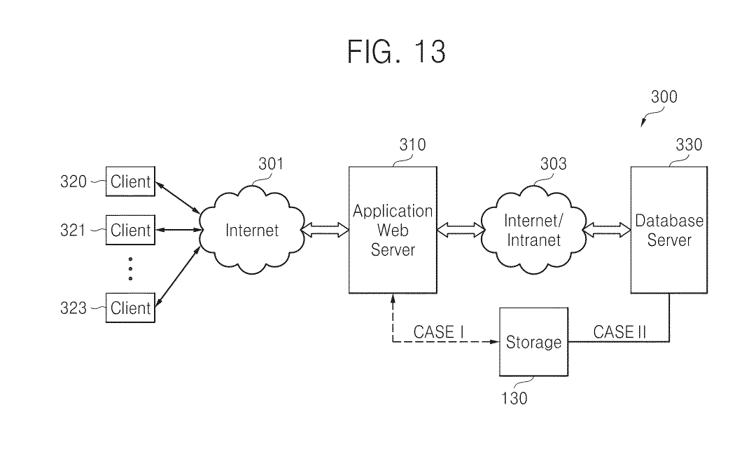

FIG. 13 is a block diagram of a system according to still another embodiment of the inventive concept.

Referring to FIG. 13, a system 300 comprises an application web server 310, multiple clients 320 to 323, and at least one data storage device 130. Application web server 310 and clients 320 to 323 form a communication network through an internet 301. Application web server 310 may perform a function of host 110. A structure and an operation of the at least one data storage device 130 are as described with reference to FIGS. 1 to 11.

Data storage device 130 according to CASE I processes data related to the atomic write transmitted from application web server 310. According to CASE II, system 300 may further comprise a data base server 330. In this case, application web server 310 and a data base server 330 may be connected to each other through an internet or an intranet 303.

In this case, data base server 330 may perform a function of host 110. Data storage device 130 may process data related to the atomic write transmitted from data base server 330.

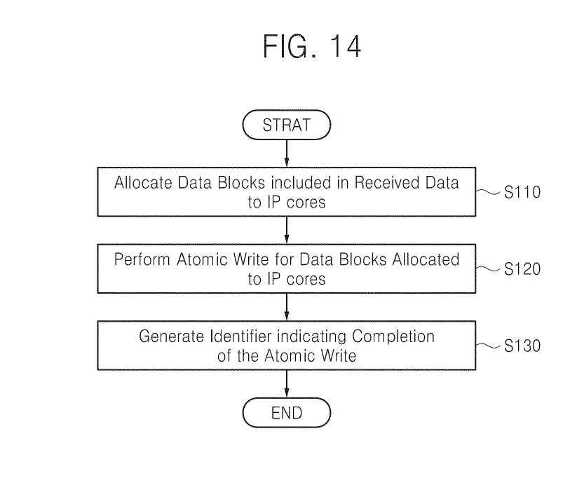

FIG. 14 is a flowchart illustrating the atomic write using multiple IP cores according to an embodiment of the inventive concept.

Referring to FIGS. 1 to 14, data storage device 130 receives the received data from host 110, and allocates data blocks B1 to B6 in the received data to each of IP cores 136-1 and 142-1 (S110). Each of IP cores 136-1 and 142-1 performs the atomic write for data blocks, allocated per an IP core 136-1 and 142-1, per IP core 136-1 and 142-1 (S120). IP cores 136-1 and 142-1 independently generate an identifier E indicating whether the atomic write is completed (S130).

FIG. 15 is a flowchart illustrating the atomic write of the data storage device comprising the capacitor, according to an embodiment of the inventive concept.

Referring to FIGS. 1 to 13, and 15, data storage device 130 receives received data from host 110, and allocates data blocks B1 to B6 of the received data to IP cores 136-1 and 142-1 (S110).

IP cores 136-1 and 142-1 perform the atomic write for data blocks, allocated per IP core 136-1 and 142-1, per IP core 136-1 and 142-1. Where SPO occurs while the atomic write for data blocks allocated per IP core 136-1 and 142-1 is performed per IP core 136-1 and 142-1, each IP core 136-1 and 142-1 performs the atomic write using a voltage or energy charged in each capacitor CAP1 and CAP2 (S123). IP cores 136-1 and 142-1 independently generate an identifier E indicating whether the atomic write is completed (S130).

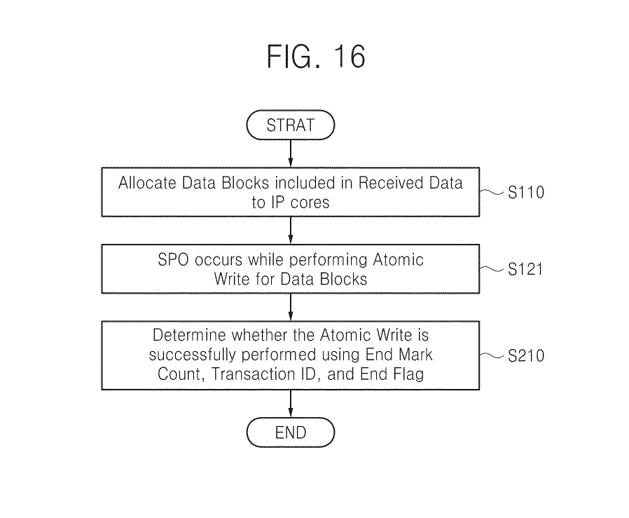

FIG. 16 is a flowchart illustrating the atomic write of the system using the metadata comprising the end mark count, the transaction ID, and the end flag, according to an embodiment of the inventive concept.

Referring to FIGS. 1 to 13, and 16, data storage device 130 receives data from host 110, and allocates data blocks B1 to B6 of the received data to IP cores 136-1 and 142-1 (S110).

IP cores 136-1 and 142-1 perform the atomic write for data blocks, allocated to IP core 136-1 and 142-1, per IP core 136-1 and 142-1. An SPO occurs while the atomic write for data blocks allocated per IP core 136-1 and 142-1 is performed per IP core 136-1 and 142-1 (S121).

Where power is again supplied to data storage device 130, IP cores 136-1 and 142-1 compare an end mark count, a transaction ID, and an end flag related to IP core 136-1 with an end mark count, a transaction ID, and an end flag related to IP core 142-1, and determines whether the atomic write is successfully performed based on a result of the comparison (S210).

As indicated by the foregoing, in a data storage device comprising multiple IP cores may support atomicity of an atomic write. The IP cores in the data storage device may independently generate an identifier indicating whether an atomic write of the IP cores is completed. In addition, the data storage device may improve a method of buffering data related to the atomic write, and accordingly reduce a size of a write buffer buffering the data.

The foregoing is illustrative of embodiments and is not to be construed as limiting thereof. Although a few embodiments have been described, those skilled in the art will readily appreciate that many modifications are possible in the embodiments without departing from the scope of the inventive concept as defined by the claims.

What is claimed is:

1. A method of operating a data storage device, comprising:
allocating a plurality of data blocks in received data to a plurality of intellectual property (IP) cores;
performing an atomic write independently for of the IP cores, wherein the atomic write for each of the IP cores writes corresponding allocated data blocks to a corresponding memory region of the data storage device; and
generating an independent identifier indicating completion of the atomic write for each of the IP cores.

2. The method of claim 1, wherein the IP cores are embodied in one central processing unit (CPU).

3. The method of claim 1, wherein each of the IP cores is disposed in a different central processing unit (CPU).

4. The method of claim 1, wherein the allocating comprises dividing the received data into groups of data blocks and allocating each of the groups to a corresponding one of the IP cores.

5. The method of claim 1, wherein the allocating comprises allocating each of the data blocks to a corresponding one of the IP cores based on respective addresses of the data blocks.

6. The method of claim 1, wherein, where a sudden power off occurs in the data storage device while the atomic write is performed on any of the IP cores, a remainder of the atomic write is performed using power stored in a capacitor.

7. The method of claim 1, further comprising storing a number of identifiers necessary for completing the atomic write and a transaction ID associated with the identifier in a storage region allocated for each of the IP cores.

8. The method of claim 7, further comprising generating a map based on whether the atomic write is successfully performed based on the identifier, the number of the identifiers, and the transaction ID.

9. The method of claim 1, wherein, performing the atomic write comprises performing the atomic write for buffered data blocks for each of the IP cores while buffering data blocks allocated for each of the IP cores.

10. The method of claim 1, wherein performing the atomic write comprises:
writing all of the data blocks in a buffer; and
performing the atomic write for data blocks allocated to each of the IP cores among data blocks written in the buffer.

11. The method of claim 1, wherein performing the atomic write comprises:
writing sequentially a previous data block and a current data block among data blocks allocated for each of the IP cores in a buffer; and
performing the atomic write for the previous data block after writing the current data block in the buffer.

12. The method of claim 1, wherein, in generating the identifier, a last data block among data blocks allocated for each of the IP cores is written in the memory region, and then the identifier is generated for each of the IP cores.

13. The method of claim 1, wherein the memory regions corresponding to the IP cores are located in a single chip.

14. The method of claim 1, wherein the memory regions corresponding to the IP cores are located in different chips.

15. The method of claim 1, wherein the data storage device is a solid state drive (SSD), a universal flash storage (UFS), a flash universal serial bus (USB) drive, or an embedded multimedia card (eMMC).

16. A method of operating a system comprising a host and a data storage device, the method comprising:
transmitting, by the host, data to the data storage device;
allocating, by the data storage device, data blocks in the data to IP cores;
performing, by the data storage device, an atomic write independently for data blocks allocated to each of the IP cores; and
generating, by the data storage device, independent identifiers indicating whether the atomic write is completed for each of the IP cores.

17. The method of claim 16, wherein, in the allocating, each of the data blocks are allocated to the IP cores based on respective addresses of the data blocks.

18. The method of claim 16, wherein performing the atomic write comprises:
writing all of the data blocks in a buffer; and
performing an atomic write for data blocks allocated for each of the IP cores among data blocks written in the buffer.

19. The method of claim 16, wherein performing the atomic write comprises:
writing sequentially a previous data block and a current data block among data blocks allocated to an IP core in a buffer; and
performing the atomic write for the previous data block after writing the current data block in the buffer.

20. The method of claim 16, wherein, in the performing the atomic write for the data blocks, where a sudden power off occurs in the data storage device while the atomic write is performed, the atomic write is performed using power stored in a capacitor.
